(19) United States
(12) Patent Application Publication
(10) Pub. No.: US 2004/0225550 A1
(43) Pub. Date: Nov. 11, 2004

(54) Software program for, system for, and method of facilitating staffing of an opening in a work schedule at a facility

(75) Inventors: Brian Helander, Phoenix, AZ (US); Timothy Ray Bauer, San Francisco, CA (US)

Correspondence Address: Kenneth A. Nelson, Bryan Cave LLP, Suite 2200, Two North Central Avenue, Phoenix, AZ, 85004-4406, US

(73) Assignee: Interactive Clinical Systems, Inc.

(21) Appl. No.: 10/431,228

(22) Filed: May 6, 2003

(51) Int. Cl. G06F 17/60

(52) U.S. Cl. 705/9

(57) ABSTRACT

A software program for facilitating staffing of an opening in a work schedule at a facility comprises subroutines capable of: receiving a listing regarding the opening via the Internet; storing the listing; broadcasting or otherwise transmitting the listing via the Internet to a plurality of recipients; receiving a plurality of acceptances of the listing via the Internet from the plurality of recipients; storing the plurality of acceptances; transmitting the plurality of acceptances via the Internet; receiving a confirmation of a first one of the plurality of acceptances via the Internet from a first one of the plurality of recipients; storing the confirmation; and transmitting the confirmation via the Internet to the first one of the plurality of recipients.

### FIELD OF THE INVENTION

This invention relates generally to staffing, and relates more particularly to staffing of an opening in a work schedule at a facility.

### BACKGROUND OF THE INVENTION

it is not uncommon for an employer to need temporary employees for help in filling an opening in a work schedule. This need for temporary employees has led to the creation of temporary staffing agencies. Such agencies coordinate the staffing of an opening in a work schedule by handling the logistics of: (i) identifying an appropriate person to staff the opening; and (ii) putting the temporary employee and the employer in touch with each other.

Currently, such coordination is an inefficient process requiring many steps. For example, the employer must first make it known to one or more staffing agencies that it has an opening to be staffed. This process is typically accomplished via telephone calls, facsimiles, e-mail messages, or the like. The agency must then locate a temporary employee with whom it has a relationship and who is willing and able to staff the opening. This process is also typically accomplished via telephone calls, facsimiles, e-mail messages, or the like. Frequently, both the employer and the staffing agency must make a large number of phone calls, or send a large number of facsimile or e-mail messages, before: (i) an appropriate temporary employee is found; (ii) his or her availability and willingness to work is confirmed; and (iii) a commitment to staff the opening obtained. Even then, in many cases the temporary employee will later withdraw the commitment to staff the opening, and the employer and the staffing agencies must go through the entire process again, this time with even less time before the temporary employee is needed. Accordingly, a need exists for a method of staffing an opening in a work schedule that does not require the inefficient, redundant, and time-consuming messaging system currently in use.

### BRIEF DESCRIPTION OF THE DRAWINGS

The invention will be better understood from a reading of the following detailed description, taken in conjunction with the accompanying figures in the drawings in which:

FIG. 1 is an illustration of a screen display generated by a first subroutine of a software program for facilitating staffing of an opening in a work schedule at a facility according to an embodiment of the invention;

FIG. 2 is an illustration of a screen display showing one example of an arrangement of information that may be displayed for viewing at the facility according to an embodiment of the invention;

FIG. 3 is an illustration of a screen display generated by a third subroutine of the software program according to an embodiment of the invention;

FIG. 4 is an illustration of a screen display generated by or in conjunction with the third subroutine of the software program according to an embodiment of the invention;

FIG. 5 is an illustration of a screen display generated by the third subroutine of the software program in conjunction with fourth, fifth, and sixth subroutines of the software program according to an embodiment of invention;

FIG. 6 is an illustration of another screen display generated by or in conjunction with the third, fourth, fifth, and sixth subroutines of the software program according to an embodiment of the invention;

FIG. 7 is an illustration of another screen display generated by or in conjunction with the third, fourth, fifth, and sixth subroutines of the software program according to an embodiment of the invention;

FIG. 8 is an illustration of another screen display generated by or in conjunction with the third, fourth, fifth, and sixth subroutines of the software program according to an embodiment of the invention;

FIG. 9 is an illustration of another screen display generated by or in conjunction with the fourth, fifth, and sixth subroutines of the software program according to an embodiment of the invention;

FIG. 10 is an illustration of another screen display generated by or in conjunction with the fourth, fifth, and sixth subroutines of the software program according to an embodiment of the invention;

FIG. 11 illustrates a screen display generated by or in conjunction with a seventh subroutine of the software program according to an embodiment of the invention;

FIG. 12 is an illustration of another screen display generated by or in conjunction with the seventh subroutine of the software program according to an embodiment of the invention;

FIG. 13 is an illustration of a screen display generated by or in conjunction with the seventh subroutine and eighth and ninth subroutines of the software program according to an embodiment of the invention;

FIG. 14 is an illustration of another screen display generated by or in conjunction with the seventh, eighth, and ninth subroutines of the software program according to an embodiment of the invention;

FIG. 15 is a flow chart illustrating a method of facilitating staffing of an opening in a work schedule at a facility according to an embodiment of the invention; and

FIG. 16 is a block diagram of a system for facilitating staffing of an opening in a work schedule according to an embodiment of the invention.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “comprise,” “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner.

### DETAILED DESCRIPTION OF THE DRAWINGS

In one embodiment of the invention, a software program for facilitating staffing of an opening in a work schedule at a facility comprises: a first subroutine capable of receiving a listing regarding the opening via the Internet; a second subroutine capable of storing the listing; a third subroutine capable of broadcasting or otherwise transmitting the listing via the Internet to a plurality of recipients; a fourth subroutine capable of receiving a plurality of acceptances of the listing via the Internet from the plurality of recipients; a fifth subroutine capable of storing the plurality of acceptances; a sixth subroutine capable of transmitting the plurality of acceptances via the Internet; a seventh subroutine capable of receiving a confirmation of a first one of the plurality of acceptances via the Internet, the first one of the plurality of acceptances received from a first one of the plurality of recipients; an eighth subroutine capable of storing the confirmation; and a ninth subroutine capable of transmitting the confirmation via the Internet to the first one of the plurality of recipients. In one embodiment, the plurality of recipients comprises: a plurality of staffing agencies; a first plurality of resources, each one of the first plurality of resources associated with at least one of the plurality of staffing agencies; and a second plurality of resources, each one of the second plurality of resources associated with the facility. In the same or another embodiment, the first through the ninth subroutines each perform their respective functions in real time.

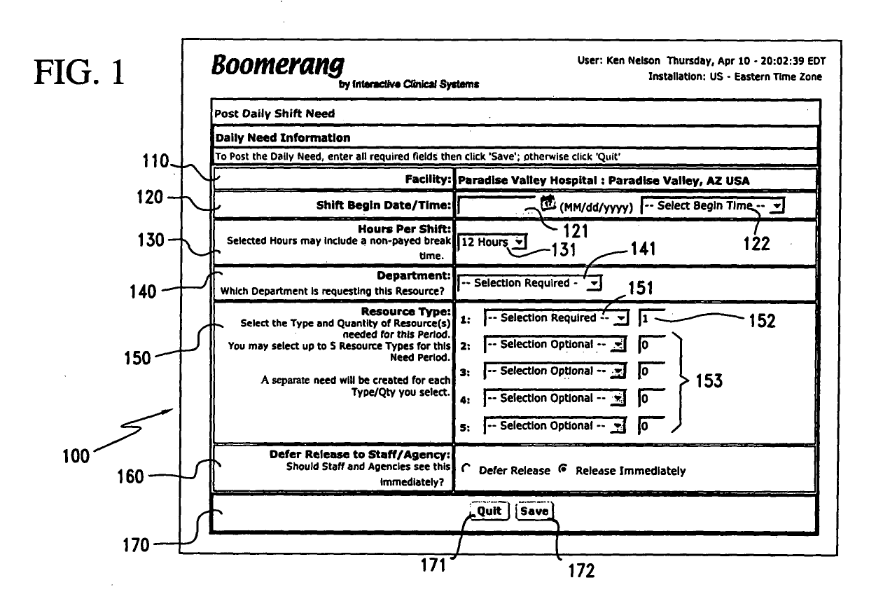

Referring now to the figures, FIG. 1 is an illustration of a screen display 100 generated by the first subroutine of the software program for facilitating staffing of an opening in a work schedule at a facility according to an embodiment of the invention. The first subroutine is capable of receiving a listing regarding the opening via the Internet. The software program of which the first subroutine is a part may be embodied on a memory, computer readable medium, or other data storage device and may run on a computer located at the facility or at another location, such as the location of another entity hired by or otherwise associated with the facility. This other entity could be an entity handling one or more aspects of the staffing process for one or more facilities. A memory, computer readable medium, or other data storage device that is part of, coupled to, or associated with the computer may contain data and information needed to operate the software program.

Screen display 100 comprises blocks 110, 120, 130, 140, 150, 160, and 170, each of which facilitate the creation of the listing to be received via the Internet. The listing may be created by the facility or by the other entity hired by or otherwise associated with the facility. Block 110 contains information regarding the employer or facility where one or more temporary workers are needed. As an example, the employer or facility can be a hospital or other health care facility, and the temporary worker can be a health care worker. As a further example, the health care worker can be a registered nurse (RN), a certified nurses aide (CNA), a licensed practical nurse (LPN), an emergency medical technician (EMT), or the like. Alternatively, the employer or facility can be a hotel, and the temporary worker can be hired to clean rooms in the hotel. Moreover, the employer or facility can be a law firm, and the temporary worker can be a secretary. The software program described herein can also be used with many other types of employers or facilities and temporary workers. Hereinafter, the word “resource” will be used to indicate any kind of temporary worker doing any kind of work for any kind of employer or facility.

Block 120 comprises a field 121 in which a beginning date for the opening in the work schedule may be entered and further comprises a field 122 in which a beginning time for the opening in the work schedule may be entered. Block 130 comprises a field 131 in which a duration from the beginning time for the opening may be entered. As an example, durations totaling four, eight, twelve, or sixteen hours may be entered in field 131. Alternatively, durations of any other length may be entered, as desired by the employer or facility.

Block 140 comprises a field 141 in which a department, subdivision, or other group within the facility may be entered. If the facility is a hospital, the departments may include, for example, behavioral health, cardiovascular intensive care unit (ICU), emergency/trauma, labor and delivery, neonatal ICU, oncology, pediatrics, and many others. Block 150 comprises a field 151 in which a type of resource for the opening may be identified. A field 152 in block 150 permits the specification of a quantity of resources needed to staff the opening. The quantity specified may range from one up to any number of resources, according to the requirements of the opening. Block 150 further comprises a plurality of fields 153, in which additional types and quantities of resources for the opening may be specified. In the illustrated embodiment, plurality of fields 153 comprises eight additional fields. Another embodiment could comprise more or fewer additional fields 153.

In block 160, a time at which to release the listing may be entered. As an example, the listing may be released immediately so that it is received via the Internet by the first subroutine in real time. As another example, the release of the listing may be deferred, and a particular time in the future may be selected for the release of the listing. Block 170 comprises a button 171 and a button 172. Button 171 allows the selections made and the information entered in blocks 120, 130, 140, 150, and 160 to be cleared and the listing to be deleted. Button 172 allows the selections made and the information entered in blocks 120, 130, 140, 150, and 160 to be saved and the listing to be released according to the timetable selected in block 160.

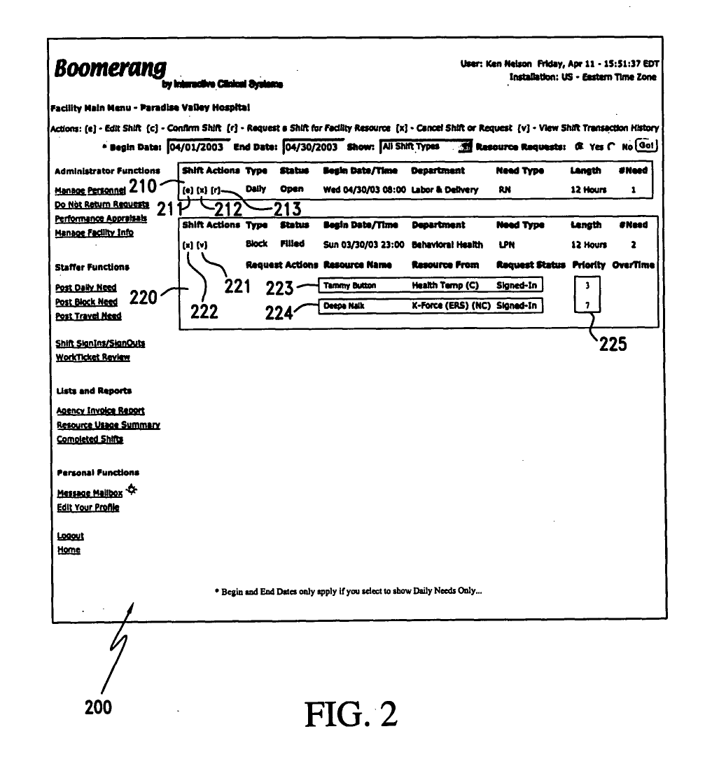

FIG. 2 is an illustration of a screen display 200 showing one example of an arrangement of information that may be displayed for viewing at the facility according to an embodiment of the invention. A block 210 displays information with respect to a listing regarding an opening in a work schedule created as described above, including, for example, a beginning date and time for the opening, a type of resource needed for the opening, a department needing the resource, a duration from the beginning time for the opening, and a quantity of resources needed for the opening. Block 210 also comprises a region 211, a region 212, and a region 213. Region 211 allows the listing to be edited, region 212 allows the listing to be canceled, and region 213 allows the facility to request that the opening be staffed by a resource with which it has a contract or a working relationship. At the stage illustrated, block 210 does not contain information regarding any particular resource because, as of the illustrated stage, none of the recipients of the listing have submitted a request to be considered for the listing.

A block 220 of screen display 200 displays information regarding a listing for which particular resources have accepted, thereby requesting consideration by the facility as a candidate to staff the opening. Accordingly, block 220 comprises a region 221 that allows a transaction history for the listing to be viewed. The transaction history can include, for example, a list of the particular resources who accepted the listing, the staffing agencies with which the particular resources are associated, arrival and departure times for the particular resource or resources who staffed the opening, and any other information related to the listing. Block 220 further comprises a region 222 allowing the cancellation of the listing. A field 223 and a field 224 of block 220 contain information relative to the particular resources actually confirmed for the opening. The manner of accepting the listing and confirming an acceptance will be further discussed below. In one embodiment, some of the information relative to the particular resources may be accessible by clicking, choosing, or otherwise selecting a particular resource. As an example, performing a mouse click on the name of a particular resource may cause certain information pertinent to the particular resource to be displayed. In the same or another embodiment, the same or other information pertinent to the particular resource may already be displayed in fields 223 and/or 224 without requiring the particular resource to be selected. As an example, the pertinent information can include: (i) personal information such as a mailing address and/or a license number; (ii) performance appraisals; (iii) work history; and/or (iv) files containing information relative to credentials or certification, such as a scanned image of a license document, or the like.

Fields 225 of block 220 contains priority and/or ranking information related to each particular resource confirmed for staffing of the opening. In one embodiment of the invention, the software program comprises a tenth subroutine capable of ranking the acceptances based on pre-determined criteria, and an eleventh subroutine capable of transmitting the acceptances to be displayed, for example, at the facility, according to the pre-determined criteria. As an example, the pre-determined criteria can include one or more of: an hourly wage of the resource; an evaluation of previous work experience for the resource; and an evaluation of a staffing agency with which the resource is associated. Based on the pre-determined criteria, each resource is given a number or other ranking by the tenth subroutine and displayed in order according to the ranking by the eleventh subroutine. The facility is then able to tell at a glance which resource most closely fits its pre-determined criteria for the selection of resources. Of course, the facility is free to choose any of the resources, not just the one with the best score or rank according to the pre-determined criteria.

After the listing is created, for example by using screen display 100 in FIG. 1, and after the first subroutine receives the listing via the Internet, the second subroutine may store the listing. As an example, the listing may be stored in memory associated with the computer, a server, or a data storage device. The third subroutine may then broadcast or otherwise transmit the listing via the Internet to a plurality of recipients, comprising: a plurality of staffing agencies; a first plurality of resources, where each one of the first plurality of resources is associated with at least one of the plurality of staffing agencies; and a second plurality of resources, where each one of the second plurality of resources is associated with the facility. As an example, the first plurality of resources can be medical workers with whom one or more staffing agencies have a working relationship, and the second plurality of resources can be medical workers with whom the facility has a contract or other working relationship.

In one embodiment, the third subroutine is capable of broadcasting or otherwise transmitting the listing to the plurality of recipients via the Internet such that each one of the plurality of recipients receives the listing simultaneously or substantially simultaneously with each other one of the plurality of recipients. In the same or another embodiment, the listing may be created, and the third subroutine may receive the listing, within one week, or within twenty-four hours, of a beginning time of the opening. In other words, the real time functionality of the software program allows the software program to facilitate staffing of openings in a work schedule at a facility even when there is very little advance notice of, and very little time left until, the beginning time of an opening in a work schedule.

In the same or another embodiment, each one of the plurality of recipients subscribes to listings of openings in the work schedule at the facility. In the same or another embodiment, each one of the plurality of recipients is pre-authorized by the facility to subscribe to all or only a portion of the listings of openings in the work schedule at the facility, so that the only entities that see or are aware of the existence of the listing or the opening are those entities that the facility wants to be aware of the listing or opening.

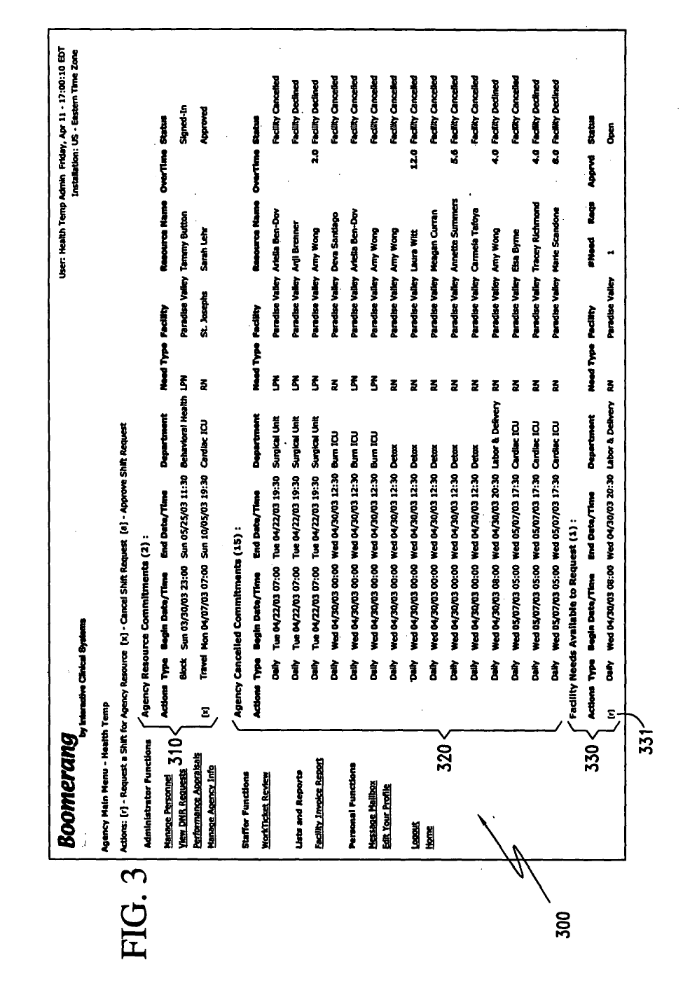

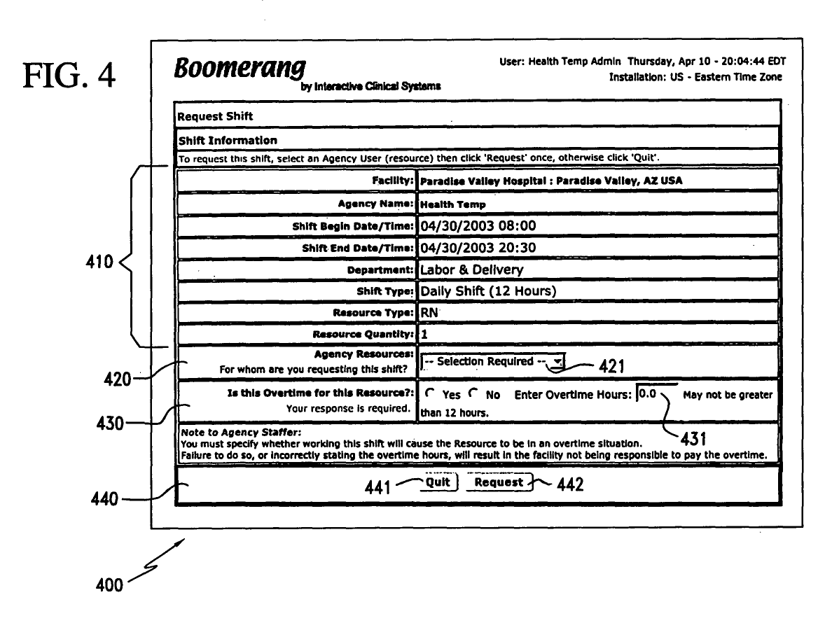

FIG. 3 is an illustration of a screen display 300 generated by the third subroutine of the software program according to an embodiment of the invention. In the illustrated embodiment, screen display 300 is for viewing by a particular one of the plurality of staffing agencies. As explained above, additional recipients, including other staffing agencies, may also be able to view the same listing. Screen display 300 comprises a block 310, a block 320, and a block 330. Block 310 contains information regarding listings previously accepted by the staffing agency and confirmed by the facility. Block 320 contains information regarding listings accepted by the staffing agency, or accepted by a resource associated with the staffing agency and subsequently approved by the staffing agency, but then declined or canceled by the facility. Block 330 contains information regarding listings available to be accepted by the staffing agency. In FIG. 3, block 330 includes information regarding the listing shown in block 210 in FIG. 2. A region 331 of block 330 allows the staffing agency to accept the listing, in a manner further explained in connection with FIG. 4.

FIG. 4 is an illustration of a screen display 400 generated by or in conjunction with the third subroutine of the software program according to an embodiment of the invention. As an example, by clicking, choosing, or otherwise selecting region 331 of block 330 in FIG. 3, the staffing agency could cause screen display 400 to be displayed on a computer screen. Screen display 400 comprises a block 410, a block 420, a block 430, and a block 440. Block 410 contains information regarding the opening that is the subject of the listing. As an example, block 410 can comprise the information entered in blocks 110, 120, 130, 140, and 150 in FIG. 1 and displayed in block 210 in FIG. 2.

Block 420 of screen display 400 allows the staffing agency to select a particular resource with whom the staffing agency is associated as the staffing agency's pick to staff the opening. If the staffing agency wishes to select more than one resource with whom it is associated to staff the opening, it may do so by returning to screen display 300 (FIG. 3) and once again selecting region 331 to be brought once again to screen display 400. This process may be repeated as many times as desired, up to a number of times equal to the number of resources with whom the staffing agency is associated that are eligible and available to staff the opening. A field 421 of block 420 allows the staffing agency to select a particular resource by name. Only the names of those resources that are eligible and available to staff the opening, for example, those with the required training and qualifications who are not already committed to other work assignments at the same time, will appear in field 421.

Block 430 of screen display 400 allows the staffing agency to indicate whether the resource selected in block 420 would incur overtime hours by staffing the opening. A field 431 of block 430 allows a quantity of such overtime hours to be entered. The information entered in block 430 may be used by the tenth subroutine to rank the acceptances received by the fourth subroutine. The ranking of acceptances by the tenth subroutine has been discussed above. Block 440 of screen display 400 allows the staffing agency to clear the information entered in blocks 420 and 430 and to delete the acceptance, by using a button 441, or to save the information and submit the request to the facility for confirmation, by using a button 442.

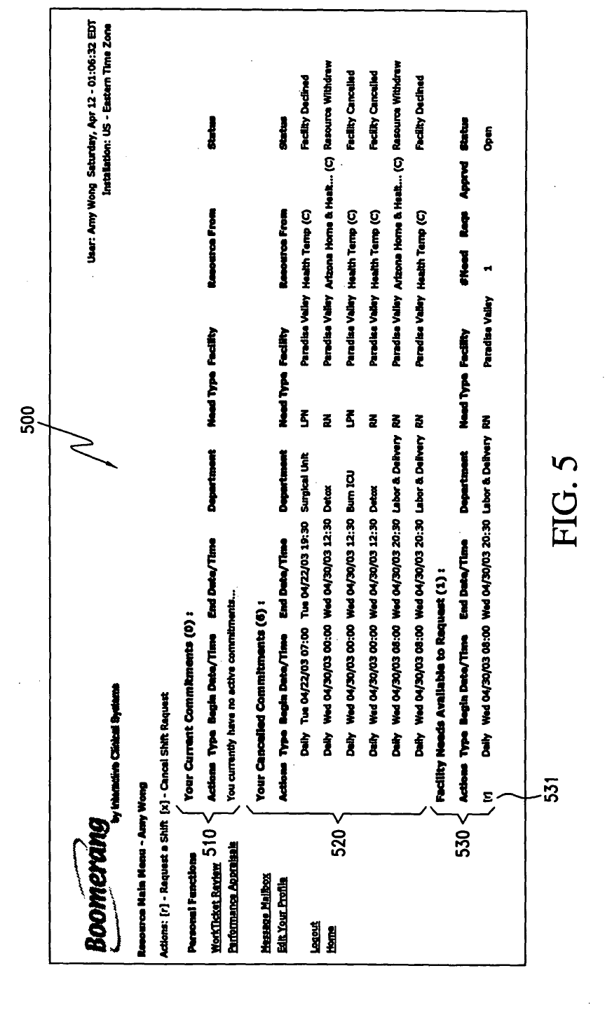

FIG. 5 is an illustration of a screen display 500 generated by the third subroutine of the software program in conjunction with the fourth, fifth, and sixth subroutines of the software program according to an embodiment of the invention. As an example, after the third subroutine has transmitted the listing via the Internet to the staffing agency and after the staffing agency has entered an acceptance of the listing, the fourth subroutine can receive the acceptance via the Internet from the staffing agency; the fifth subroutine can store the acceptance on a server, a computer, or a data storage device; and the sixth subroutine can transmit the acceptance via the Internet to the facility.

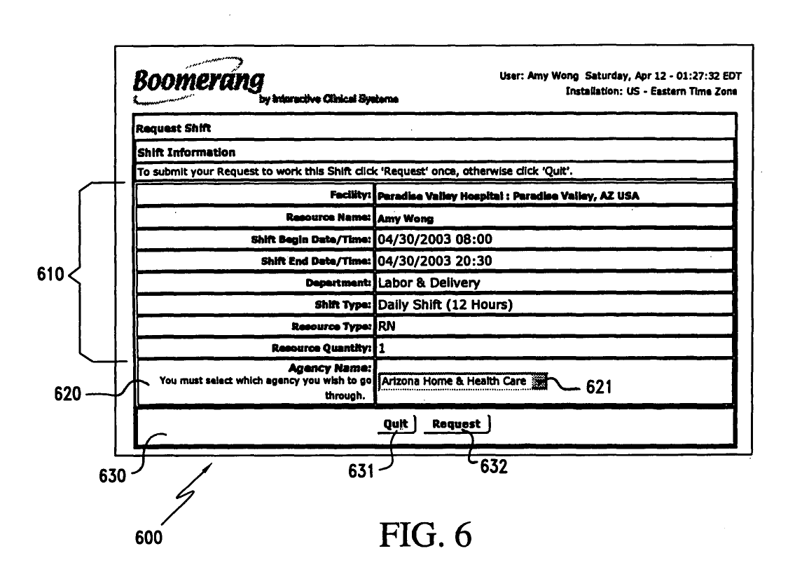

Screen display 500 is an example of a screen display for viewing by a particular one of the first plurality of resources. As explained above, additional recipients, including other ones of the first plurality of resources, may also be able to view the same listing. In one embodiment, only those particular ones of the first plurality of resources who are qualified to staff the opening and who are not already committed to another work assignment will be able to view the listing. Screen display 500 comprises a block 510, a block 520, and a block 530. Block 510 contains information regarding listings previously accepted by the particular one of the first plurality of resources, approved by a staffing agency with which the particular one of the first plurality of resources is associated, and confirmed by the facility. Block 520 contains information regarding listings accepted by the particular one of the first plurality of resources, but then declined or canceled by the facility or rescinded by the particular one of the first plurality of resources or by the staffing agency with which the particular one of the first plurality of resource is associated. Block 530 contains information regarding listings available to be accepted by the particular one of the first plurality of resources. In FIG. 5, block 530 includes information regarding the listing shown in block 210 in FIG. 2. A region 531 of block 530 allows the particular one of the first plurality of resources to accept the listing, in a manner further explained in connection with FIG. 6.

The fourth, fifth, and sixth subroutines may also function to allow the facility to view acceptances entered by the recipients. For example, the fourth subroutine may be further capable of receiving via the Internet a first acceptance of the listing from the first one of the plurality of recipients and receiving via the Internet a second acceptance of the listing from the first one of the plurality of recipients, where the first one of the plurality of recipients is one of the plurality of staffing agencies. In one embodiment, the facility can confirm via the Internet the first acceptance, regardless of whether the first acceptance is received via the Internet by the fourth subroutine before or after the second acceptance. Similarly, the facility could instead confirm the second acceptance regardless of the order in which it was received. In one embodiment, the first acceptance can be associated with a resource from the first and second plurality of resources, and the second acceptance can be associated with a resource from the first and second plurality of resources that is different from the resource associated with the first acceptance.

FIG. 6 is an illustration of a screen display 600 generated by or in conjunction with the third, fourth, fifth, and sixth subroutines of the software program according to an embodiment of the invention. As an example, by clicking, choosing, or otherwise selecting region 531 of block 530 in FIG. 5, the particular one of the first plurality of resources could cause screen display 600 to be displayed on a computer screen. Screen display 600 comprises a block 610, a block 620, and a block 630. Block 610 contains information regarding the opening that is the subject of the listing. As an example, block 610 can comprise the information entered in blocks 110, 120, 130, 140, and 150 in FIG. 1 and displayed in block 210 of FIG. 2. Block 620 allows the particular one of the first plurality of resources to select a staffing agency through which to submit the acceptance. A window 621 of block 620 contains a list of all the staffing agencies with which the particular one of the first plurality of resources has a working relationship. Block 630 of screen display 600 allows the particular one of the first plurality of resources to quit without accepting the listing, by using a button 631, or to save the information and submit the request, by using a button 632.

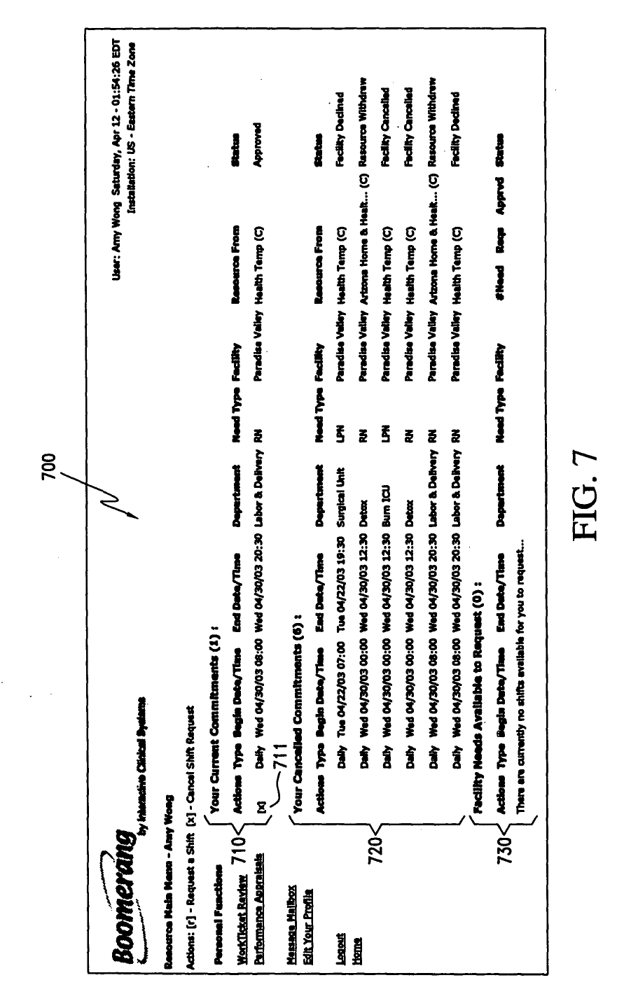

FIG. 7 is an illustration of a screen display 700 generated by or in conjunction with the third, fourth, fifth, and sixth subroutines of the software program according to an embodiment of the invention. Screen display 700 is an example of a screen display for viewing by a particular one of the first plurality of resources after the particular one of the first plurality of resources has been selected via the Internet by a staffing agency to staff the opening. For example, the staffing agency could enter the name of the particular one of the first plurality of resources in field 421 in FIG. 4, during the staffing agency's acceptance of the listing, described above.

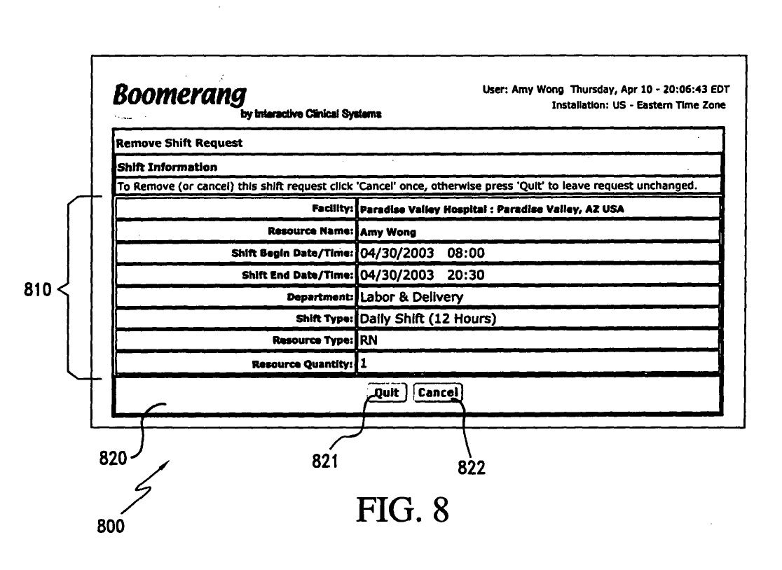

Screen display 700 comprises a block 710, a block 720, and a block 730. Block 710 contains information regarding the listing which the staffing agency has accepted. In FIG. 7, block 710 includes information regarding the listing shown in block 210 in FIG. 2. A region 711 of block 710 allows the particular one of the first plurality of resources to rescind the acceptance and decline the listing, in a manner further explained in connection with FIG. 8. Block 720 contains information regarding listings accepted by the particular one of the first plurality of resources, but then declined or canceled by the facility or rescinded by the particular one of the first plurality of resources. Block 730 contains information regarding listings available to be accepted by the particular one of the first plurality of resources.

FIG. 8 is an illustration of a screen display 800 generated by or in conjunction with the third, fourth, fifth, and sixth subroutines of the software program according to an embodiment of the invention. As an example, by clicking, choosing, or otherwise selecting region 711 of block 710 in FIG. 7, the particular one of the first plurality of resources could cause screen display 800 to be displayed on a computer screen. Screen display 800 comprises a block 810 and a block 820. Block 810 contains information regarding the opening that is the subject of the listing. As an example, block 810 can comprise the information entered in blocks 110, 120, 130, 140, and 150 in FIG. 1 and displayed in block 210 of FIG. 2. Block 820 of screen display 800 allows the particular one of the first plurality of resources to quit without rescinding the acceptance, by using a button 821, or to rescind the acceptance and decline the listing via the Internet, by using a button 822.

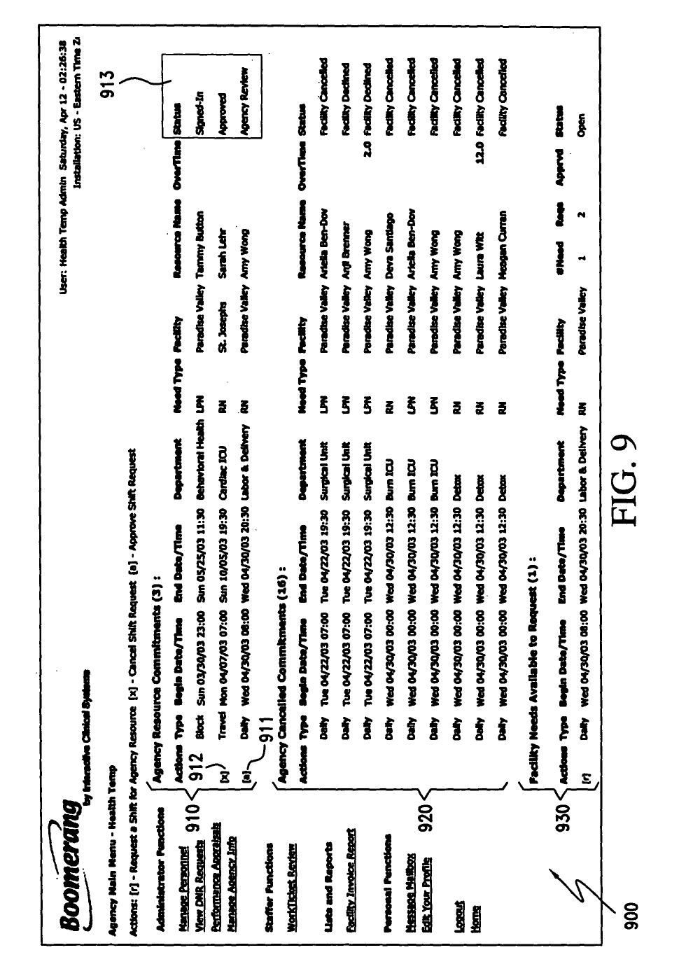

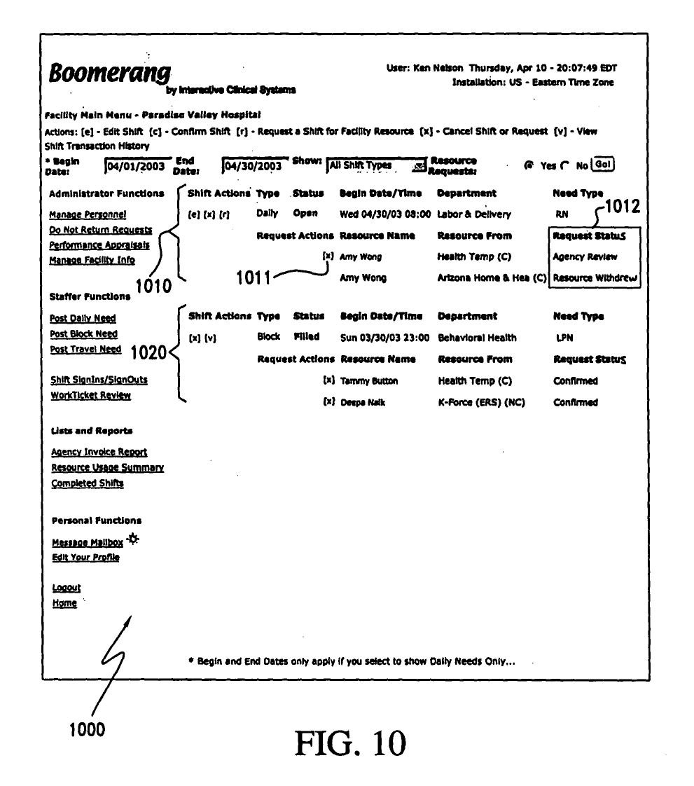

FIG. 9 is an illustration of a screen display 900 generated by or in conjunction with the fourth, fifth, and sixth subroutines of the software program according to an embodiment of the invention. As an example, screen display 900 can be for viewing by a staffing agency after the software program receives an acceptance via the Internet of the opening from the particular one of the first plurality of resources. In one embodiment of the invention, a staffing agency with which the particular one of the first plurality of resources is associated must approve the acceptance entered by the particular one of the first plurality of resources before the facility can confirm the acceptance via the Internet. The facility can, however, view and, if desired, decline via the Internet the acceptance entered by the particular one of the first plurality of resources even before the staffing agency approves via the Internet the acceptance entered by the particular one of the first plurality of resources, as shown in FIG. 10. In another embodiment of the invention, the facility may directly confirm via the Internet an acceptance entered by any one of the plurality of recipients, including any one of the first plurality of resources, without another one of the plurality of recipients, such as a staffing agency, first needing to approve an acceptance via the Internet. The staffing agency also can decline to approve the acceptance entered by the particular one of the first plurality of resources before or after confirmation by the facility.

Screen display 900 comprises a block 910, a block 920, and a block 930. Block 910 contains information regarding listings accepted by the staffing agency or by a particular one of the first plurality of resources associated with the staffing agency. A region 911 of block 910 allows the staffing agency to approve the acceptance of the listing entered by the particular one of the first plurality of resources. If the acceptance of the listing had been first entered by the staffing agency, instead of by the particular one of the first plurality of resources, the staffing agency approval of the acceptance would have been automatic, and would have been inherent in the acceptance step. A region 912 of block 910 allows the staffing agency to cancel an earlier-entered approval of an acceptance. A column 913 of block 910 contains information regarding a status of each listing in block 910. For example, the status may be: (i) “signed-in,” meaning the resource has reported for work to staff the opening and has signed in to a tracking system at the facility; (ii) “approved”; or (iii) awaiting staffing “agency review.”

Block 920 contains information regarding listings accepted by the staffing agency, or by a particular one of the first plurality of resources, but then declined or canceled by the facility or rescinded by the particular one of the first plurality of resources. Block 930 contains information regarding listings available for the staffing agency to accept. Even if a particular listing has been accepted by a particular one of the first plurality of resources, and whether or not the acceptance has been approved by the staffing agency, the particular listing remains in block 930, and the staffing agency could, if desired, accept the particular listing on behalf of a different one of the first plurality of resources with whom it is associated.

FIG. 10 illustrates a screen display 1000 generated by or in conjunction with the fourth, fifth, and sixth subroutines of the software program according to an embodiment of the invention. Screen display 1000 is an example of a screen display that may be displayed for viewing by a facility, or another entity associated with the facility, after the software program receives a plurality of acceptances of the listing via the Internet. Screen display 1000 comprises a block 1010 and a block 1020. Block 1010 displays information regarding the listing created in blocks 110, 120, 130, 140, and 150 in FIG. 1, and displayed in block 210 in FIG. 2. Block 1010 may display the names of, and other information about, all of the resources who accepted the listing. A region 1011 of block 1010 allows the facility to decline or otherwise reject the acceptance of a particular one of the resources. A region 1012 of block 1010 allows the facility to view a status of a particular acceptance. As an example, the status may be: (i) awaiting “agency review”; (ii) “resource withdrew,” meaning the particular one of the resources accepted the listing and later rescinded the acceptance; or (iii) “approved,” meaning the staffing agency associated with the particular one of the resources approved the acceptance entered by the particular one of the resources.

Block 1020 contains information about other listings, possibly including other listings for which appropriate resources have already been confirmed.

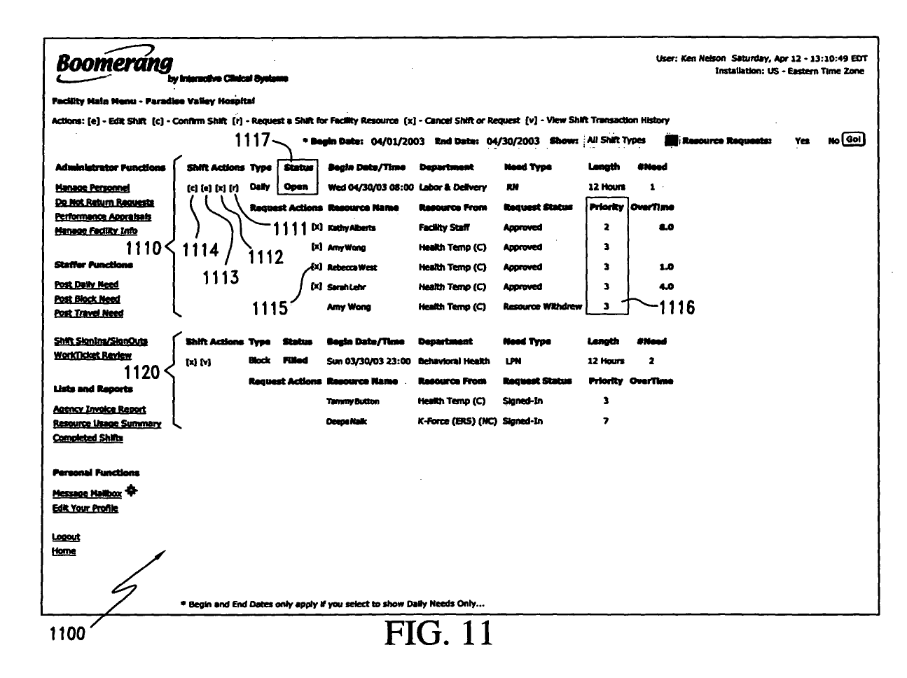

FIG. 11 illustrates a screen display 1100 generated by or in conjunction with the seventh subroutine of the software program according to an embodiment of the invention. As an example, the seventh subroutine can cause screen display 1100 to be displayed via the Internet on a computer at the facility or at another location chosen by the facility. Screen display 1100 can be used to create a confirmation of an acceptance of the listing. Screen display 1100 comprises a block 110 and a block 1120. Block 1110 contains information regarding the listing, such as the information entered in blocks 110, 120, 130, 140, and 150 of FIG. 1 and displayed in block 210 of FIG. 2. Block 1110 also contains information regarding particular ones of the first and second plurality of resources who have accepted the listing. Block 1110 comprises a region 1111, a region 1112, a region 1113, a region 1114, a plurality of regions 1115, a region 1116, and a region 1117. Region 1111 allows the facility to accept the listing on behalf of one of the second plurality of resources. Region 1112 allows the facility to cancel the listing. Region 1113 allows the facility to edit the listing, and region 1114 allows the facility to confirm one or more of the acceptances. Each one of plurality of regions 1115 allows the facility to cancel or reject a particular one of the acceptances. Region 1116 displays ranking or ordering information, such as that generated by or in conjunction with the tenth subroutine and displayed by or in conjunction with the eleventh subroutine. The ranking or ordering information contained in region 1116 may assist the facility to make a choice about which of the acceptances to confirm. As explained above, the facility may confirm any of the acceptances, not just the acceptances that have the best rankings. Region 1117 contains information regarding a status of the listing. For example, the status may be “open,” meaning one or more resources to staff the opening still need to be confirmed, or the status may be “filled,” meaning one or more appropriate resources have been confirmed for the opening. Block 1120 of screen display 1100 contains information regarding other listings, possibly including other listings for which appropriate resources have already been confirmed.

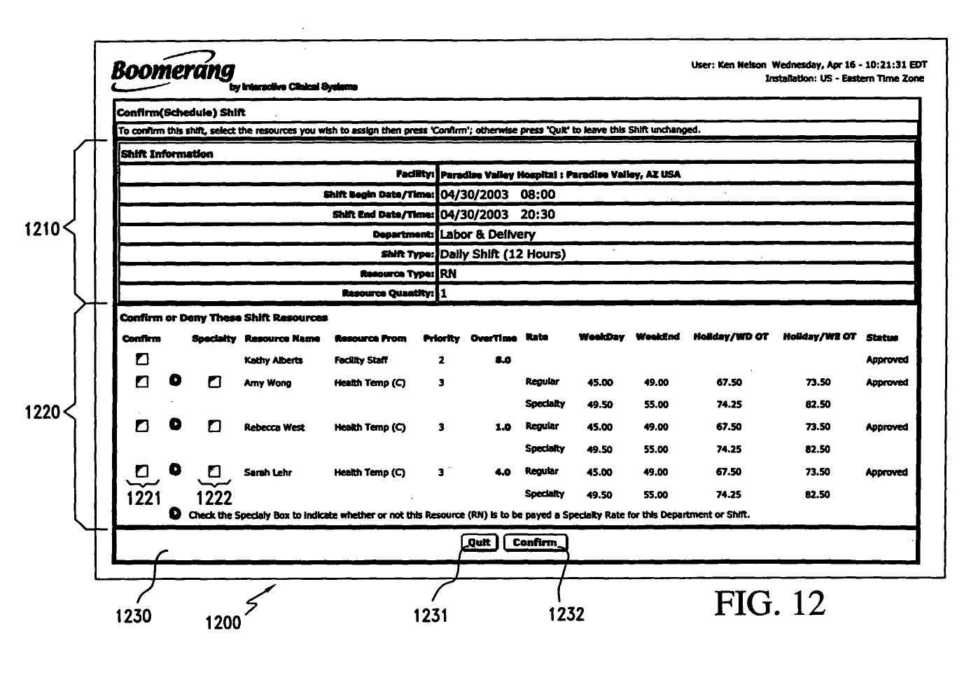

FIG. 12 is an illustration of a screen display 1200 generated by or in conjunction with the seventh subroutine of the software program according to an embodiment of the invention. As an example, by clicking, choosing, or otherwise selecting region 1114 of block 1110 in FIG. 11, the facility could cause screen display 1200 to be displayed via the Internet on a computer screen. Screen display 1200 comprises a block 1210, a block 1220, and a block 1230. Block 1210 contains information regarding the opening that is the subject of the listing. As an example, block 1210 can comprise the information entered in blocks 110, 120, 130, 140, and 150 in FIG. 1 and displayed in block 210 of FIG. 2. Block 1220 of screen display 1200 allows the facility to select and confirm one or more of the acceptances for the listing.

Block 1220 contains information regarding each one of the first and second plurality of resources who have accepted the listing, including their names, the staffing agency with which they are associated, a quantity of their overtime hours, if any, and their pay rates for different pay periods. Other information could also be included in block 1220. Block 1220 comprises a plurality of regions 1221 and a plurality of regions 1222. A particular one of plurality of regions 1221 can be checked, clicked, or otherwise selected by the facility to confirm the acceptance of the corresponding one of the first and second plurality of resources who accepted the listing and are displayed in block 1220. A particular one of plurality of regions 1222 can be checked, clicked, or otherwise selected by the facility to indicate whether the corresponding one of the first plurality of resources who accepted the listing is to be paid a specialty rate for staffing the opening that it the subject of the listing. Block 1230 of screen display 1200 allows the facility to quit without confirming a particular one or ones of the acceptances, by using a button 1231, or to confirm a particular one or ones of the acceptances, by using a button 1232.

After the facility confirms one or more acceptances, for example, by using screen displays 1100 (FIG. 11) and 1200, an eighth subroutine of the software program may store the confirmation, on a computer, a server, or a data storage device, and a ninth subroutine of the software program may transmit the confirmation via the Internet to the resource or resources who entered the acceptances that were confirmed. In one embodiment, only the resource or resources whose acceptances were confirmed is permitted to view the confirmation. In another embodiment, both the resource or resources and the staffing agencies associated with the resource or resources may view the confirmation. In yet another embodiment, all staffing agencies and resources may view the confirmation.

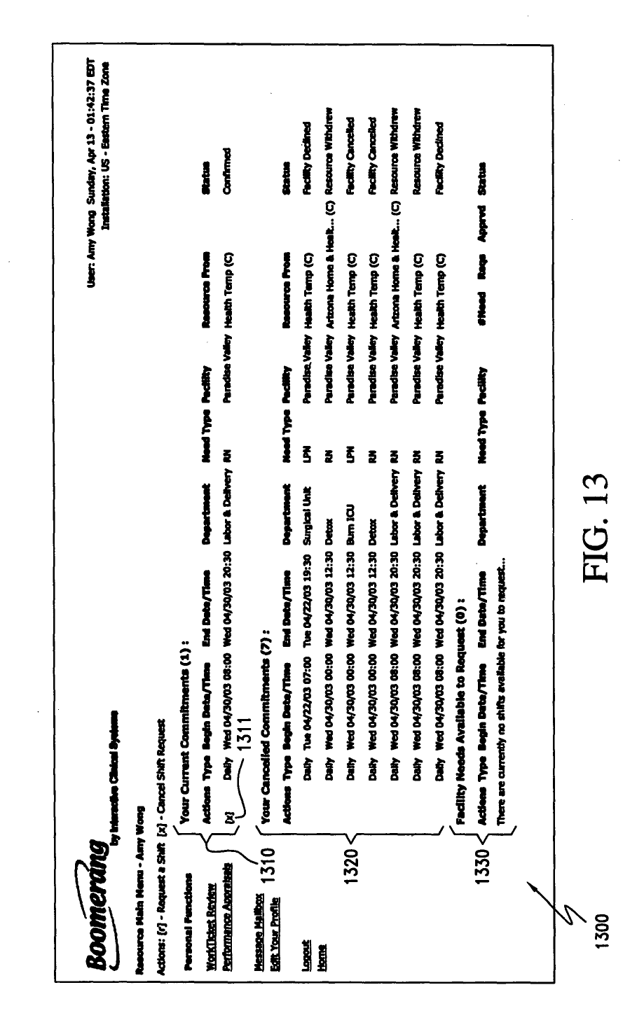

FIG. 13 is an illustration of a screen display 1300 generated by or in conjunction with the seventh, eighth, and ninth subroutines of the software program according to an embodiment of the invention. As an example, the seventh, eighth, and ninth subroutines may cause screen display 1300 to be displayed on a computer viewable by a resource whose acceptance was confirmed by the facility. Screen display 1300 comprises a block 1310, a block 1320, and a block 1330. Block 1310 contains information regarding the opening that is the subject of the listing. As an example, block 1310 can comprise the information entered in blocks 110, 120, 130, 140, and 150 in FIG. 1 and displayed in block 210 of FIG. 2. A region 1311 of block 1310 allows the resource to rescind the acceptance or otherwise cancel the commitment to staff the opening.

Block 1320 of screen display 1300 contains information regarding listings accepted by the resource via the Internet, but then declined or canceled by the facility via the Internet or rescinded by the resource via the Internet. Block 1330 contains information regarding listings available for the resource to accept.

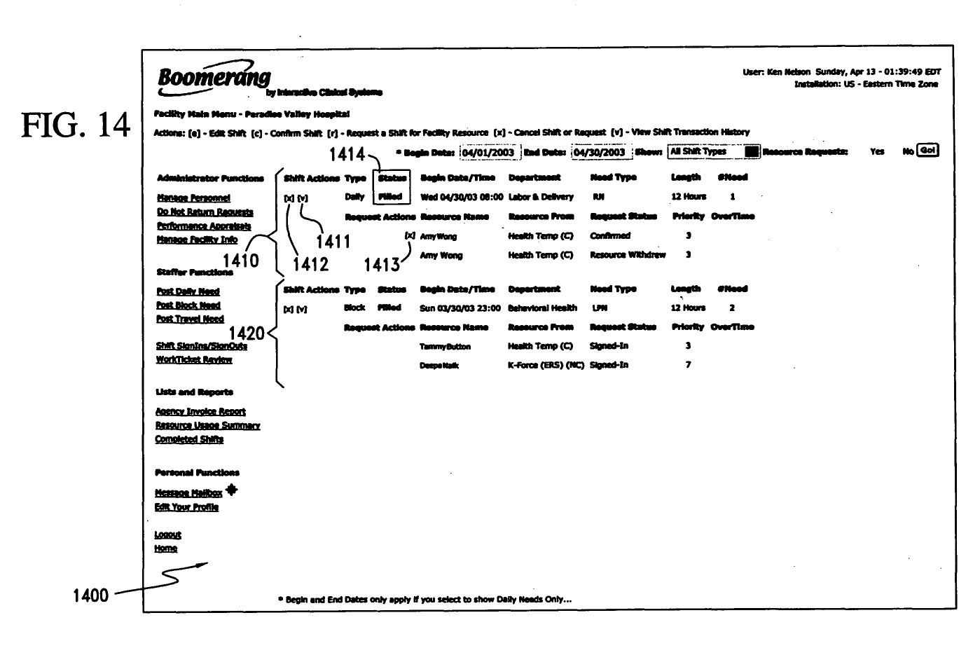

FIG. 14 is an illustration of a screen display 1400 generated by or in conjunction with the seventh, eighth, and ninth subroutines of the software program according to an embodiment of the invention. As an example, screen display 1400 can be displayed on a computer at the facility or at another location chosen by the facility. Screen display 1400 comprises a block 1410 and a block 1420. Block 1410 contains information regarding the listing, such as the information entered in blocks 110, 120, 130, 140, and 150 of FIG. 1 and displayed in block 210 of FIG. 2. Block 1410 also contains information regarding the resource or resources whose acceptances have been confirmed. Block 1410 comprises a region 1411, a region 1412, a region 1413, and a region 1414. Region 1411 allows the facility to view via the Internet a transaction history for the opening that is the subject of the listing. As an example, the transaction history can comprise some or all of the information discussed in connection with FIGS. 1-13, above. Region 1412 allows the facility to cancel the listing via the Internet. Region 1413 allows the facility to rescind the confirmation via the Internet of a particular one of the resources who has earlier been confirmed. Region 1414 contains information regarding a status of the listing. For example, as explained above, the status may be “open,” meaning one or more resources to staff the opening still need to be confirmed, or the status may be “filled,” meaning one or more appropriate resources have been confirmed for the opening. Block 1420 of screen display 1400 contains information regarding other listings, possibly including other listings for which appropriate resources have already been confirmed.

In one embodiment of the invention, the software program further comprises a twelfth subroutine capable of receiving the rescission of the confirmation via the Internet. If the facility rescinds a confirmation of a resource who has earlier been confirmed, the twelfth subroutine may be used. In one embodiment, the twelfth subroutine may cause the rescission of the confirmation to be viewed at the facility. The software program may further comprise: a thirteenth subroutine capable of storing the rescission, for example on a computer, a server, or a data storage device; a fourteenth subroutine capable of re-broadcasting or otherwise re-transmitting the listing via the Internet to the plurality of recipients after receiving the rescission; a fifteenth subroutine capable of receiving additional acceptances regarding the listing via the Internet from the plurality of recipients after re-broadcasting or otherwise re-transmitting the listing; a sixteenth subroutine capable of storing the additional acceptances; and a seventeenth subroutine capable of transmitting the additional acceptances via the Internet. In one embodiment, the additional acceptances may be transmitted to the facility.

The facility, staffing agencies, and resources for whom the software program of the present invention is designed may desire that access to the software program via the Internet be restricted to authorized personnel only. Accordingly, in one embodiment of the invention, the software program further comprises: an eighteenth subroutine capable of receiving a first user name and a first password via the Internet; a nineteenth subroutine capable of verifying the first user name and first password to permit creation of the listing and the confirmation of the one of the plurality of acceptances; a twentieth subroutine capable of receiving additional user names and additional passwords via the Internet from the plurality of recipients; and a twenty-first subroutine capable of verifying the additional user names and the additional passwords to permit the plurality of acceptances of the listing.

In the same or another embodiment, the software program further comprises a twenty-second subroutine capable of transmitting a message regarding an action item related to the opening via the Internet to at least one of the plurality of recipients. For example, the action item can be an e-mail, an instant message, or a pop-up window on a computer screen to a staffing agency to the effect that an acceptance has been entered by one of the plurality of resources associated with the staffing agency that is pending approval by the staffing agency. As another example, the action item can be an e-mail, an instant message, or a pop-up window on a computer screen to the facility to the effect that an acceptance has been approved and is awaiting confirmation. In a particular embodiment of the invention, the software program further comprises: a twenty-third subroutine capable of grouping a plurality of action items according to one or more of a first plurality of pre-determined criteria; a twenty-fourth subroutine capable of ranking the plurality of action items according to one or more of a second plurality of pre-determined criteria; and a twenty-fifth subroutine capable of transmitting a message regarding the plurality of action items to be displayed according to the grouping and ranking via the Internet to at least one of the plurality of recipients. As an example, all of the acceptances awaiting approval can be grouped together on a staffing agency's computer screen by the twenty-third subroutine, and the group of acceptances awaiting approval can be placed above or below other groups of action items on the staffing agency's computer screen according to the importance or urgency of the items in the groups. The urgency or importance can be determined based on pre-determined criteria.

In the same or another embodiment, the software program can further comprise a twenty-sixth subroutine capable of associating files with the first and second plurality of resources. In one embodiment, the twenty-sixth subroutine can transmit the file via the Internet to the facility, receive files to be associated with the first and second plurality of resources via the Internet from the facility, store the files on a computer, a server, or a data storage device. As an example, the files can be documents regarding the certification of a resource, personal or contact information regarding a resource, or the like.

In the same or another embodiment, the software program can further comprise a twenty-seventh subroutine capable of receiving a report via the Internet and comprising information related to work performed during the opening. As an example, the information in the report can comprise one or more of: a number of hours worked during the opening; a fee due for each hour worked during the opening; an arrival time during the opening; a departure time during the opening; and an evaluation of work performed during the opening. In one embodiment, the twenty-seventh subroutine is further capable of storing the report on a computer, a server, or a data storage device.

In the same or another embodiment, the software program can further comprise: a twenty-eighth subroutine capable of receiving via the Internet a third acceptance of the listing from a third one of the plurality of recipients after transmitting the first and second acceptances via the Internet; a twenty-ninth subroutine capable of ranking the first, second, and third acceptances based on the pre-determined criteria; and a thirtieth subroutine capable of transmitting via the Internet the first, second, and third acceptances to be displayed, e.g., at the facility, according to the pre-determined criteria before receiving the confirmation.

In the same or another embodiment, the software program can further comprise a thirty-first subroutine capable of broadcasting or otherwise transmitting via the Internet the listing, the plurality of acceptances, and the confirmation to automatically update a computer screen display at one or more pre-determined intervals. As an example, the automatic updates can take place every two minutes.

In the same or another embodiment the software program can further comprise a thirty-second subroutine capable of purging or canceling inactive listings. As an example, the thirty-second subroutine can cancel any listings that have not been confirmed as of the beginning time for the opening in the work schedule. In one embodiment, if none of the plurality of recipients has accepted the listing, the thirty-second subroutine can delete the listing. In the same or another embodiment, if at least one of the plurality of recipients has accepted the listing but the acceptance has nevertheless not been confirmed by the beginning time for the opening in the work schedule, the thirty-second subroutine can set the status of the listing to “canceled” or the like, and the status may be viewable in, for example, block 320 in FIG. 3, block 520 in FIG. 5, block 720 in FIG. 7, block 920 in FIG. 9, and/or block 1320 in FIG. 13. As an example, blocks 320, 520, 720, 920, and 1320 can show that the listing was canceled by a system administrator.

In the same or another embodiment the software program can further comprise a thirty-third subroutine capable of deleting, finalizing, or otherwise closing a listing. As an example, the thirty-third subroutine can close a listing after the opening in the work schedule that was the subject of the listing has been staffed. As a further example, the thirty-third subroutine can close any confirmed listing for which no resource has signed in or signed out. As a particular example, the thirty-third subroutine can close confirmed listings staffed by a resource or resources from the second plurality of resources, which resources may not be required, or may not have the ability, to sign in to or sign out of the tracking system first mentioned above in connection with column 913 of screen display 900 in FIG. 9.

In the same or another embodiment the software program can further comprise a thirty-fourth subroutine capable of monitoring the staffing of an opening. As an example, once an acceptance for a listing has been confirmed, a work ticket may be created by the software program to keep track of various parameters associated with the listing. The thirty-fourth subroutine may be capable of monitoring the work ticket to determine whether the resource confirmed to staff the opening signs in and out of the tracking system as scheduled. If the resource does not sign in to the tracking system by the beginning time for the opening, the thirty-fourth subroutine can monitor, record, display, or otherwise keep track of: (i) whether the resource staffed none of the opening; (ii) whether the resource staffed a portion of the opening; and, if the resource staffed a portion of the opening, (iii) an amount of time by which the beginning time for the opening preceded an actual sign-in time for the resource.

In the same or another embodiment the software program can further comprise a thirty-fifth subroutine capable of monitoring whether a resource signs out of the tracking system after staffing an opening. As an example, the thirty-fifth subroutine can automatically change the status of a listing to “signed-out” at a pre-determined time, whether or not the resource actually signed out at that or at any other time. This automatic change in status to “signed-out” can be changed if it is determined that that automatic change in status was made in error.

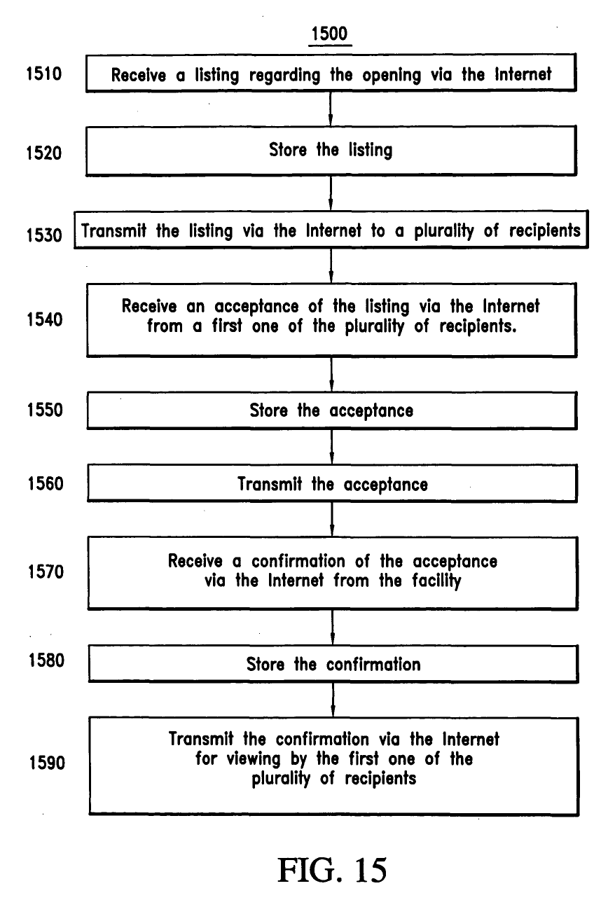

FIG. 15 is a flow chart illustrating a method 1500 of facilitating staffing of an opening in a work schedule at a facility according to an embodiment of the invention. A step 1510 of method 1500 is to receive a listing regarding the opening via the Internet. A step 1520 of method 1500 can further comprise storing the listing. As an example, storing the listing can comprise storing the listing on a computer, a server, or a data storage device.

A step 1530 of method 1500 is to broadcast or otherwise transmit the listing via the Internet to a plurality of recipients. As an example, the plurality of recipients can comprise: a plurality of staffing agencies; a first plurality of resources, where each one of the first plurality of resources associated with at least one of the plurality of staffing agencies; and a second plurality of resources, where each one of the second plurality of resources associated with the facility.

A step 1540 of method 1500 is to receive an acceptance of the listing via the Internet from a first one of the plurality of recipients. A step 1550 of method 1500 can further comprise storing the acceptance on a computer, a server, or a data storage device. A step 1560 of method 1500 can further comprise transmitting the plurality of acceptances via the Internet.

A step 1570 of method 1500 is to receive a confirmation of the acceptance via the Internet from the facility. A step 1580 of method 1500 can further comprise storing the confirmation on a computer, a server, or a data storage device. A step 1590 of method 1500 is to transmit the confirmation via the Internet for viewing by the first one of the plurality of recipients.

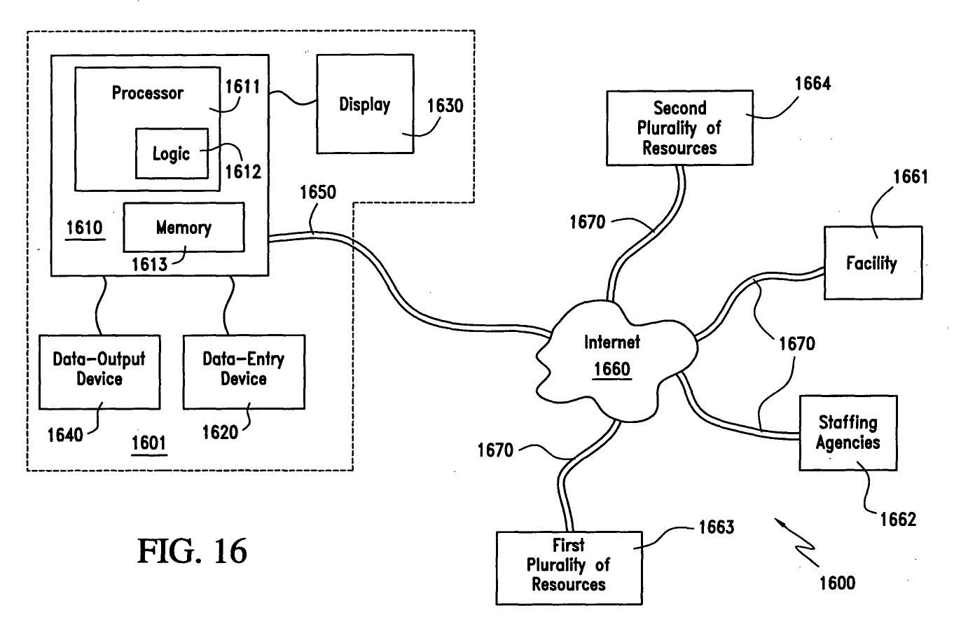

FIG. 16 is a block diagram of a system 1600 for facilitating staffing of an opening in a work schedule according to an embodiment of the invention. System 1600 comprises a computer system 1601, which in turn comprises a computer 1610, a data-entry device 1620 coupled to computer 1610 and capable of entering data into system 1600, a display 1630 coupled to computer 1610 and capable of displaying data entered into system 1600, a data-output device 1640 coupled to computer 1610, and a connection 1650 between computer 1610 and a global information network 1660. Computer 1610 comprises a processor 1611 and a memory 1613 controlled by processor 1611 and capable of storing data entered into the system. Processor 1611 comprises logic 1612, which is capable of manipulating data entered into system 1600. As an example, the software program described previously with reference to FIGS. 1-15 can be embodied or stored on memory 1613 to be run on computer 1610 of computer system 1601. As another example, the listing, acceptance, confirmation, rescission, etc. described previously with reference to FIGS. 1-15 can also be embodied or stored on memory 1613. As a further example, data-entry device 1620 may comprise a keyboard, a mouse, or the like; display 1630 may be a computer monitor or the like; data-output device 1640 may be a printer or the like; and global information network 1660 may be the Internet.

System 1600 further comprises global information network 1660 and a plurality of connections 1670 connecting global information network 1660 to one or more computer systems at a facility 1661, computer systems at a plurality of staffing agencies 1662, computer systems at a first plurality of resources 1663, and computer systems at a second plurality of resources 1664. As an example, each of these computer systems can be similar to computer system 1601.

Although the invention has been described with reference to specific embodiments, it will be understood by those skilled in the art that various changes may be made without departing from the spirit or scope of the invention. Various examples of such changes have been given in the foregoing description. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the software program discussed herein may be implemented in a variety of embodiments, and that the foregoing discussion of certain of these embodiments does not necessarily represent a complete description of all possible embodiments.

Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A software program for facilitating staffing of an opening in a work schedule at a facility, the software program comprising:
a first subroutine capable of receiving a listing regarding the opening via the Internet;
a second subroutine capable of storing the listing;
a third subroutine capable of transmitting the listing via the Internet to a plurality of recipients, the plurality of recipients comprising:
a plurality of staffing agencies;
a first plurality of resources, each one of the first plurality of resources associated with at least one of the plurality of staffing agencies; and
a second plurality of resources, each one of the second plurality of resources associated with the facility;
a fourth subroutine capable of receiving a plurality of acceptances of the listing via the Internet from the plurality of recipients;
a fifth subroutine capable of storing the plurality of acceptances;
a sixth subroutine capable of transmitting the plurality of acceptances via the Internet;
a seventh subroutine capable of receiving a confirmation of a first one of the plurality of acceptances via the Internet, the first one of the plurality of acceptances received from a first one of the plurality of recipients;
an eighth subroutine capable of storing the confirmation; and
a ninth subroutine capable of transmitting the confirmation via the Internet to the first one of the plurality of recipients.

2. The software program of claim 1 wherein:
the first subroutine receives the listing from the facility;
the sixth subroutine transmits the acceptance to the facility; and
the seventh subroutine receives the confirmation from the facility.

3. The software program of claim 1 wherein:
the third subroutine is further capable of:
simultaneously transmitting the listing to the plurality of recipients, each one of the plurality of recipients subscribing to listings of openings in the work schedule at the facility.

4. The software program of claim 3 wherein:
the third subroutine is further capable of:
simultaneously transmitting the listing to the plurality of recipients, each one of the plurality of recipients authorized by the facility to subscribe to listings of openings in the work schedule at the facility.

5. The software program of claim 1 further comprising:
a tenth subroutine capable of receiving a rescission of the confirmation via the Internet;
an eleventh subroutine capable of storing the rescission;
a twelfth subroutine capable of re-transmitting the listing via the Internet to the plurality of recipients after receiving the rescission;
a thirteenth subroutine capable of receiving additional acceptances regarding the listing via the Internet from the plurality of recipients after re-transmitting the listing;
a fourteenth subroutine capable of storing the additional acceptances; and
a fifteenth subroutine capable of transmitting the additional acceptances via the Internet.

6. The software program of claim 1 wherein:
the first subroutine is further capable of:
receiving information for the listing comprising at least one of:
a quantity of resources for the opening;
a type of resource for the opening;
a department needing the resource for the opening;
a beginning date for the opening;
a beginning time for the opening; and
a duration from the beginning time for the opening.

7. The software program of claim 1 wherein:
the first subroutine is further capable of:
receiving a pre-determined time at which to transmit the listing to the plurality of recipients.

8. The software program of claim 1 wherein:
the first, second, third, fourth, fifth, sixth, seventh, eighth, and ninth subroutines are further capable of:
receiving the listing, storing the listing, transmitting the listing, receiving the plurality of acceptances, storing the plurality of acceptances, transmitting the plurality of acceptances, receiving the confirmation, storing the confirmation, and transmitting the confirmation, respectively, in real time.

9. The software program of claim 1 further comprising:
a tenth subroutine capable of receiving a first user name and a first password via the Internet; and
an eleventh subroutine capable of verifying the first user name and first password to permit creation of the listing and confirmation of the one of the plurality of acceptances;
a twelfth subroutine capable of receiving additional user names and additional passwords via the Internet from the plurality of recipients; and
a thirteenth subroutine capable of verifying the additional user names and the additional passwords to permit the plurality of acceptances of the listing.

10. The software program of claim 1 further comprising:
a tenth subroutine capable of transmitting a message regarding an action item related to the opening via the Internet to at least one of the plurality of recipients.

11. The software program of claim 1 further comprising:
a tenth subroutine capable of grouping a plurality of action items according to one or more of a first plurality of pre-determined criteria;
an eleventh subroutine capable of ranking the plurality of action items according to one or more of a second plurality of pre-determined criteria; and
a twelfth subroutine capable of transmitting a message regarding the plurality of action items to be displayed according to the grouping and ranking, via the Internet to at least one of the plurality of recipients.

12. The software program of claim 1 further comprising:
a tenth subroutine capable of associating files with the first and second plurality of resources.

13. The software program of claim 1 further comprising:
a tenth subroutine capable of receiving a report comprising information related to work performed during the opening, wherein the information comprises one or more of:
a number of hours worked during the opening;
a fee due for each hour worked during the opening;
an arrival time during the opening;
a departure time during the opening; and
an evaluation of work performed during the opening; and
storing the report.

14. The software program of claim 1 wherein:
the fourth subroutine is further capable of:
receiving a first acceptance of the listing from the first one of the plurality of recipients; and
receiving a second acceptance of the listing from the first one of the plurality of recipients,
the first one of the plurality of recipients is one of the plurality of staffing agencies; and
the first one of the plurality of acceptances is the first acceptance.

15. The software program of claim 14 wherein:
the fourth subroutine is further capable of:
receiving the first acceptance before receiving the second acceptance.

16. The software program of claim 14 wherein:
the fourth subroutine is further capable of:
receiving the second acceptance before receiving the first acceptance.

17. The software program of claim 14 further comprising:
a tenth subroutine capable of ranking the first and second acceptances based on pre-determined criteria; and
an eleventh subroutine capable of transmitting the first and second acceptances to be displayed according to the pre-determined criteria before receiving the confirmation.

18. The software program of claim 17 wherein:
the first acceptance is associated with a resource from the first and second plurality of resources;
the second acceptance is associated with a resource from the first and second plurality of resources that is different from the resource associated with the first acceptance; and
the tenth subroutine is further capable of:
ranking the first and second acceptances based on pre-determined criteria comprising one or more of:
an hourly wage of the resource;
an evaluation of previous work experience with the resource; and
a staffing agency with which the resource is associated.

19. The software program of claim 14 wherein:
the fourth subroutine is further capable of:
receiving an acceptance of the listing from a first one of the first plurality of resources;
storing the acceptance of the listing from the first one of the first plurality of resources; and
transmitting the acceptance from the first one of the first plurality of resources to the first one of the plurality of staffing agencies associated with the first one of the first plurality of resources; and
receiving the first acceptance of the listing from the first one of the plurality of staffing agencies occurs after transmitting the acceptance from the first one of the first plurality of resources to the first one of the plurality of staffing agencies.

20. The software program of claim 1 wherein:
the fourth subroutine is further capable of:
receiving a first acceptance of the listing from the first one of the plurality of recipients; and
receiving a second acceptance of the listing from a second one of the plurality of recipients; and
the first one of the plurality of acceptances is the first acceptance.

21. The software program of claim 20 wherein:
the fourth subroutine is further capable of:
receiving the first acceptance before receiving the second acceptance.

22. The software program of claim 20 wherein:
the fourth subroutine is further capable of:
receiving the second acceptance before receiving the first acceptance.

23. The software program of claim 20 further comprising:
a tenth subroutine capable of ranking the first and second acceptances based on pre-determined criteria; and
an eleventh subroutine capable of transmitting the first and second acceptances to be displayed according to the pre-determined criteria before receiving the confirmation.

24. The software program of claim 23 wherein:
the first acceptance is associated with a resource from the first and second plurality of resources;
the second acceptance is associated with a resource from the first and second plurality of resources that is different from the resource associated with the first acceptance; and
the tenth subroutine is further capable of:
ranking the first and second acceptances based on pre-determined criteria comprising one or more of:
an hourly wage of the resource;
an evaluation of previous work experience with the resource; and
a staffing agency with which the resource is associated.

25. The software program of claim 20 further comprising:
a tenth subroutine capable of receiving a third acceptance of the listing from a third one of the plurality of recipients after transmitting the first and second acceptances.

26. The software program of claim 25 further comprising:
an eleventh subroutine capable of ranking the first, second, and third acceptances based on pre-determined criteria; and
a twelfth subroutine capable of transmitting the first, second, and third acceptances to be displayed according to the pre-determined criteria before receiving the confirmation.

27. The software program of claim 1 further comprising:
a tenth subroutine capable of transmitting the listing, the plurality of acceptances, and the confirmation to automatically update a computer screen display at one or more pre-determined intervals.

28. The software program of claim 1 wherein:
receiving the listing occurs within one week of a beginning time of the opening.

29. The software program of claim 1 wherein:
receiving the listing occurs within twenty-four hours of a beginning time of the opening.

30. The software program of claim 1 wherein:
the facility comprises a hospital; and
the work schedule is for health care workers.

31. A computer system for facilitating staffing of an opening in a work schedule at a facility, the computer system for use with a global information network and comprising:
a computer comprising:
a processor having logic capable of manipulating data entered into the system;
a memory controlled by the processor capable of storing data entered into the system;
a data-entry device coupled to the computer capable of entering data into the system;
a display coupled to the computer capable of displaying data entered into the system;
a data-output device coupled to the computer;
a connection between the computer and the global information network; and
a software program embodied on the memory, the software program comprising:
a first subroutine capable of receiving a listing regarding the opening via the global information network;
a second subroutine capable of storing the listing;
a third subroutine capable of transmitting the listing via the global information network to a plurality of recipients, the plurality of recipients comprising:
a plurality of staffing agencies;
a first plurality of resources, each one of the first plurality of resources associated with at least one of the plurality of staffing agencies; and
a second plurality of resources, each one of the second plurality of resources associated with the facility;
a fourth subroutine capable of receiving a plurality of acceptances of the listing via the global information network from the plurality of recipients;
a fifth subroutine capable of storing the plurality of acceptances;
a sixth subroutine capable of transmitting the plurality of acceptances via the global information network;
a seventh subroutine capable of receiving a confirmation of a first one of the plurality of acceptances via the global information network, the first one of the plurality of acceptances received from a first one of the plurality of recipients;
an eighth subroutine capable of storing the confirmation; and
a ninth subroutine capable of transmitting the confirmation via the global information network to the first one of the plurality of recipients.

32. A method of facilitating staffing of an opening in a work schedule at a facility, the method comprising:
receiving a listing regarding the opening via the Internet;
transmitting the listing via the Internet to a plurality of recipients;
receiving an acceptance of the listing via the Internet from a first one of the plurality of recipients;
receiving a confirmation of the acceptance via the Internet from the facility; and
transmitting the confirmation via the Internet for viewing by the first one of the plurality of recipients.

33. A method of facilitating staffing of an opening in a work schedule at a facility, the method comprising:
receiving a listing regarding the opening via the Internet;
storing the listing;
transmitting the listing via the Internet to a plurality of recipients, the plurality of recipients comprising:
a plurality of staffing agencies;
a first plurality of resources, each one of the first plurality of resources associated with at least one of the plurality of staffing agencies; and
a second plurality of resources, each one of the second plurality of resources associated with the facility;
receiving a plurality of acceptances of the listing via the Internet from the plurality of recipients;
storing the plurality of acceptances;
transmitting the plurality of acceptances via the Internet;
receiving a confirmation of a first one of the plurality of acceptances via the Internet, the first one of the plurality of acceptances received from a first one of the plurality of recipients;
storing the confirmation; and
transmitting the confirmation via the Internet to the first one of the plurality of recipients.

34. The method of claim 33 wherein:
receiving the listing comprises receiving the listing from the facility;
transmitting the acceptance comprises transmitting the acceptance to the facility; and
receiving the confirmation comprises receiving the confirmation from the facility.

35. The method of claim 33 wherein:
transmitting the listing comprises:
simultaneously transmitting the listing to the plurality of recipients, each one of the plurality of recipients subscribing to listings of openings in the work schedule at the facility.

36. The method of claim 35 wherein:
simultaneously transmitting the listing comprises:
simultaneously transmitting the listing to the plurality of recipients, each one of the plurality of recipients authorized by the facility to subscribe to listings of openings in the work schedule at the facility.

37. The method of claim 33 further comprising:
receiving a rescission of the confirmation via the Internet;
storing the rescission;
after receiving the rescission, re-transmitting the listing via the Internet to the plurality of recipients;
after re-transmitting the listing, receiving additional acceptances regarding the listing via the Internet from the plurality of recipients;
storing the additional acceptances; and
transmitting the additional acceptances via the Internet.

38. The method of claim 33 wherein:
receiving the listing comprises:
receiving information for the listing comprising at least one of:
a quantity of resources for the opening;
a type of resource for the opening;
a department needing the resource for the opening;
a beginning date for the opening;
a beginning time for the opening; and
a duration from the beginning time for the opening.

39. The method of claim 33 wherein:
receiving the listing further comprises:
receiving a pre-determined time at which to transmit the listing to the plurality of recipients.

40. The method of claim 33 wherein:
receiving the listing, storing the listing, transmitting the listing, receiving the plurality of acceptances, storing the plurality of acceptances, transmitting the plurality of acceptances, receiving the confirmation, storing the confirmation, and transmitting the confirmation further comprises:
receiving the listing, storing the listing, transmitting the listing, receiving the plurality of acceptances, storing the plurality of acceptances, transmitting the plurality of acceptances, receiving the confirmation, storing the confirmation, and transmitting the confirmation in real time.

41. The method of claim 33 further comprising:
receiving a first user name and a first password via the Internet; and
verifying the first user name and first password to permit creation of the listing and confirmation of the one of the plurality of acceptances;
receiving additional user names and additional passwords via the Internet from the plurality of recipients; and
to verifying the additional user names and the additional passwords to permit the plurality of acceptances of the listing.

42. The method of claim 33 further comprising:
transmitting a message regarding an action item related to the opening via the Internet to at least one of the plurality of recipients.

43. The method of claim 33 further comprising:
grouping a plurality of action items according to one or more of a first plurality of pre-determined criteria;
ranking the plurality of action items according to one or more of a second plurality of pre-determined criteria; and
transmitting a message regarding the plurality of action items to be displayed according to the grouping and ranking, via the Internet to at least one of the plurality of recipients.

44. The method of claim 33 further comprising:
associating files with the first and second plurality of resources.

45. The method of claim 33 further comprising:
receiving a report comprising information related to work performed during the opening, wherein the information comprises one or more of:
a number of hours worked during the opening;
a fee due for each hour worked during the opening;
an arrival time during the opening;
a departure time during the opening; and
an evaluation of work performed during the opening; and
storing the report.

46. The method of claim 33 wherein:
receiving the plurality of acceptances comprises:
receiving a first acceptance of the listing from the first one of the plurality of recipients; and
receiving a second acceptance of the listing from the first one of the plurality of recipients;
the first one of the plurality of recipients is one of the plurality of staffing agencies; and
the first one of the plurality of acceptances is the first acceptance.

47. The method of claim 46 wherein:
receiving the first acceptance further comprises:
receiving the first acceptance before receiving the second acceptance.

48. The method of claim 46 wherein:
receiving the second acceptance further comprises:
receiving the second acceptance before receiving the first acceptance.

49. The method of claim 46 further comprising:
ranking the first and second acceptances based on pre-determined criteria; and
transmitting the first and second acceptances to be displayed according to the pre-determined criteria before receiving the confirmation.

50. The method of claim 49 wherein:
the first acceptance is associated with a resource from the first and second plurality of resources;
the second acceptance is associated with a resource from the first and second plurality of resources that is different from the resource associated with the first acceptance; and
ranking the first and second acceptances comprises:
ranking the first and second acceptances based on pre-determined criteria comprising one or more of:
an hourly wage of the resource;
an evaluation of previous work experience with the resource; and
a staffing agency with which the resource is associated.

51. The method of claim 46 wherein:
receiving the plurality of acceptances further comprises:
receiving an acceptance of the listing from a first one of the first plurality of resources;
storing the acceptance of the listing from the first one of the first plurality of resources;
transmitting the acceptance from the first one of the first plurality of resources to the first one of the plurality of staffing agencies associated with the first one of the first plurality of resources; and
receiving the first acceptance of the listing from the first one of the plurality of recipients occurs after transmitting the acceptance from the first one of the first plurality of resources to the first one of the plurality of recipients.

52. The method of claim 33 wherein:
receiving the plurality of acceptances comprises:
receiving a first acceptance of the listing from the first one of the plurality of recipients; and
receiving a second acceptance of the listing from a second one of the plurality of recipients; and
the first one of the plurality of acceptances is the first acceptance.

53. The method of claim 52 wherein:
receiving the first acceptance further comprises:
receiving the first acceptance before receiving the second acceptance.

54. The method of claim 52 wherein:
receiving the second acceptance further comprises:
receiving the second acceptance before receiving the first acceptance.

55. The method of claim 52 further comprising:
ranking the first and second acceptances based on pre-determined criteria; and
transmitting the first and second acceptances to be displayed according to the pre-determined criteria before receiving the confirmation.

56. The method of claim 55 wherein:
the first acceptance is associated with a resource from the first and second plurality of resources;
the second acceptance is associated with a resource from the first and second plurality of resources that is different from the resource associated with the first acceptance; and
ranking the first and second acceptances comprises:
ranking the first and second acceptances based on pre-determined criteria comprising one or more of:
an hourly wage of the resource;
an evaluation of previous work experience with the resource; and
a staffing agency with which the resource is associated.

57. The method of claim 52 further comprising:
receiving a third acceptance of the listing from a third one of the plurality of recipients after transmitting the first and second acceptances.

58. The method of claim 57 further comprising:
ranking the first, second, and third acceptances based on pre-determined criteria; and
transmitting the first, second, and third acceptances to be displayed according to the pre-determined criteria before receiving the confirmation.

59. The method of claim 33 further comprising:
transmitting the listing, the plurality of acceptances, and the confirmation to automatically update a computer screen display at one or more pre-determined intervals.

60. The method of claim 33 wherein:
receiving the listing occurs within one week of a beginning time of the opening.

61. The method of claim 33 wherein:
receiving the listing occurs within twenty-four hours of a beginning time of the opening.

62. The method of claim 33 wherein:
the facility comprises a hospital; and
the work schedule is for health care workers.
